(19) United States
(12) Patent Application Publication
(10) Pub. No.: US 2014/0062899 A1
(43) Pub. Date: Mar. 6, 2014

(54) DYNAMIC STOP DISPLAY DRIVING MECHANISM FOR TOUCH SENSING

(71) Applicants: Hsin-Te Lee, Hsinchu (TW); Chih-Hsiang Yang, Hsinchu (TW); Huang-De Lin, Hsinchu (TW)

(72) Inventors: Hsin-Te Lee, Hsinchu (TW); Chih-Hsiang Yang, Hsinchu (TW); Huang-De Lin, Hsinchu (TW)

(73) Assignee: AU OPTRONICS CORPORATION, Hsinchu (TW)

(21) Appl. No.: 13/601,412

(22) Filed: Aug. 31, 2012

(51) Int. Cl. G06F 3/041

(52) U.S. Cl. 345/173

(57) ABSTRACT

A method for driving a touch display for sensing a touch event and displaying an image characterized with a series of frames includes performing a driving operation for a display device of the touch display to display the image, and a sensing operation for a touch sensing device of the touch display to sense a touch event. The driving operation is configured such that for selected frames of the series of frames, the display device is not driven, and for the other frames of the series of frames, the display device is driven. The sensing operation is configured such that during the selected frames in which the display device is not driven, the touch sensing device is driven, and during the other frames in which the display device is driven, the touch sensing device is not driven.

### FIELD OF THE DISCLOSURE

The disclosure relates generally to touch sensing technology, and more particularly to methods and systems that utilize dynamic stop display driving mechanisms for touch sensing of a touch display.

### BACKGROUND OF THE DISCLOSURE

A touch display device usually includes a touch sensing device and a liquid crystal display (LCD) device, where the display device is controlled by display driving integrated circuit (DDIC), while the touch sensing device is controlled by a touch sensing device driving integrated circuit (TPIC). For a mutual capacitance type touch sensing device, it typically has a plurality of sensing lines spatially arranged along a row direction and a plurality of scanning lines spatially arranged crossing over the plurality of sensing lines along a column direction. In operation, TPIC acquires signals sensed by the sensing lines when each scanning line starts being scanned, and processes the acquired signals to determine whether a touch event occurs and the coordinates of the touch event if occurred.

However, the touch sensing is very susceptible to interference of noises generated by the driving of the display device, which can easily lead to malfunction of the touch sensing. To avoid the interference from the display device, usually, the touch sensing is synchronized with the driving of the display device such that the touch sensing is performed during display blanking.

In addition, the touch sensing needs a certain amount of charging time to obtain a sufficient level of signals. Generally, a horizontal-blanking time is about to complete a couple of sensing signal detections. Further, the touch sensing is also subject to interference from other external signals, such as electromagnetic interference from chargers, mobile phones, etc. The touch sensing may need to repeatedly sample sensing nodes so as to filter out wrong information, or to change the time or frequency of the touch driving so as to avoid the interference of particular frequency bands. In many cases, the horizontal-blanking time is not longer enough for the touch scanning to adopt appropriate adjustments of the touch driving and sensing. Vertical-blanking has a longer time interval that can facility multiple burst touch scannings, however, waiting for the next vertical-blanking to do touch scanning adjustments may delay responding time of touch events and reduce its operability.

Therefore, a heretofore unaddressed need exists in the art to address the aforementioned deficiencies and inadequacies.

### SUMMARY OF THE DISCLOSURE

In one aspect, the disclosure relates to a method for driving a touch display for sensing a touch event and displaying an image characterized with a series of frames. In one embodiment, the method includes driving a touch sensing device of the touch display in frame and line blanking periods to sense a touch event; providing a touch detection signal such that when a touch event is sensed, the touch detection signal is set from a low level to a high level for a time period; detecting the touch detection signal in each frame blanking period; driving a display device of the touch display when the touch detection signal is in the low level, and when the touch detection signal is in the high level, stopping driving the display device in at least one frame immediately after the corresponding frame of the start of the high level until the touch detection signal is in the low level; and driving the touch sensing device to sense the touch event during the at least one frame immediately after the corresponding frame of the start of the high level of the touch detection signal in which the display device is not driven. The display device and the touch sensing device are integrated into a single in-cell touch display panel or stacked up in separate layers. The display device and the touch sensing device are integrated into a single in-cell touch display panel or stacked up in separate panels/layers.

In another aspect, the disclosure relates to a driving system for a touch display for sensing a touch event and displaying an image characterized with a series of frames. In one embodiment, the system includes a display driving controller configured for driving a display device of the touch display to display the image; and a touch sensing controller configured for sensing a touch event of a touch sensing device of the touch display. The display device and the touch sensing device are integrated into a single in-cell touch display panel or stacked up in separate panels/layers.

The display driving controller and the touch sensing controller are synchronized with each other such that in operation, the touch sensing controller drives the touch sensing device in frame and line blanking periods to sense the touch event, and provides a touch detection signal such that when a touch event is sensed, the touch detection signal is set from a low level to a high level for a time period; the display driving controller detects the touch detection signal in each frame blanking period, drives the display device when the touch detection signal is in the low level, and when the touch detection signal is in the high level, stops driving the display device in at least one frame immediately after the corresponding frame of the start of the high level until the touch detection signal is in the low level; and the touch sensing controller drives the touch sensing device to sense the touch event during the at least one frame immediately after the corresponding frame of the start of the high level of the touch detection signal in which the display device is not driven.

In yet another aspect, the disclosure relates to a method for driving a touch display for sensing a touch event and displaying an image characterized with a series of frames. In one embodiment, the method includes driving a touch sensing device of the touch display in frame and line blanking periods to sense a touch event; driving a display device of the touch display, and when a touch event is sensed in a blanking period, stopping driving the display device in a frame immediately after the frame blanking period; and driving the touch sensing device to sense the touch event by burst sensing during the frame immediately after the corresponding frame of the frame blanking period, which is a longer period than frame blanking period or line blanking period, in which the display device is not driven.

In a further aspect, the disclosure relates to a driving system for a touch display for sensing a touch event and displaying an image characterized with a series of frames. In one embodiment, the system includes a display driving controller configured for driving a display device of the touch display to display the image; and a touch sensing controller configured for sensing a touch event of a touch sensing device of the touch display.

The display driving controller and the touch sensing controller are synchronized with each other such that in operation, the touch sensing controller drives the touch sensing device in frame and line blanking periods to sense a touch event; the display driving controller drives the display device, and when a touch event is sensed in a blanking period, stops driving the display device in a frame immediately after the frame blanking period; and the touch sensing controller drives the touch sensing device to sense the touch event by burst sensing during the frame immediately after the frame blanking period, which is a longer period than frame blanking period or line blanking period, in which the display device is not driven.

In one aspect, the disclosure relates to a method for driving a touch display for sensing a touch event and displaying an image characterized with a series of frames. In one embodiment, the method includes performing a driving operation for a display device of the touch display, and a sensing operation for a touch sensing device of the touch display. The driving operation is configured such that for selected frames of the series of frames, the display device is not driven, and for the other frames of the series of frames, the display device is driven. The sensing operation is configured such that during the selected frames in which the display device is not driven, the touch sensing device is driven, and during the other frames in which the display device is driven, the touch sensing device is not driven.

In another aspect, the disclosure relates to a driving system for a touch display for sensing a touch event and displaying an image characterized with a series of frames, where the display device and the touch sensing device are integrated into a single in-cell touch display panel or stacked up in separate panels/layers. In one embodiment, the driving system includes a display driving controller configured for driving a display device of the touch display to display the image; and a touch sensing controller configured for sensing a touch event of a touch sensing device of the touch display, where the display driving controller and the touch sensing controller are synchronized with each other such that when the display device is not driven during the selected frames of the series of frames, the touch sensing device is driven, and when the display device is driven during the other frames of the series of frames, the touch sensing device is not driven.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 shows schematically a touch display according to one embodiment of the disclosure;

FIG. 2 shows schematically a driving scheme for a touch display according to one embodiment of the disclosure;

FIG. 3 shows schematically a driving scheme for a touch display according to another embodiment of the disclosure;

FIG. 4 shows schematically a flowchart of operations of a display driving controller to drive a touch display according to one embodiment of the disclosure;

FIG. 5 shows schematically a flowchart of operations of a touch sensing controller to drive a touch display according to one embodiment of the disclosure;

FIG. 6 shows schematically a driving scheme for a touch display according to one embodiment of the disclosure;

FIG. 7 shows schematically a driving scheme for a touch display according to another embodiment of the disclosure;

FIG. 8 shows schematically a driving scheme for a touch display according to yet a further embodiment of the disclosure;

FIG. 9 shows schematically a driving scheme for a touch display according to yet another embodiment of the disclosure;

FIG. 10 shows schematically a driving scheme for a touch display according to a further embodiment of the disclosure; and

FIG. 11 shows schematically a driving scheme for a touch display according to yet a further embodiment of the disclosure.

### DETAILED DESCRIPTION OF THE DISCLOSURE

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The term “vertical synchronization signal” or its acronym “VSYNC”, as used herein, refers to a synchronization signal representing a beginning of each and every frame of a series of frames of an image displayed on a display device.

The term “horizontal synchronization signal” or its acronym “HSYNC”, as used herein, refers to a synchronization signal representing a beginning of line scanning of each and every line of a plurality of scan lines of a display device.

As used herein, the term “display trigger” or “display trigger signal” refers to an enable signal to enable/start display driving or disable/stop display driving.

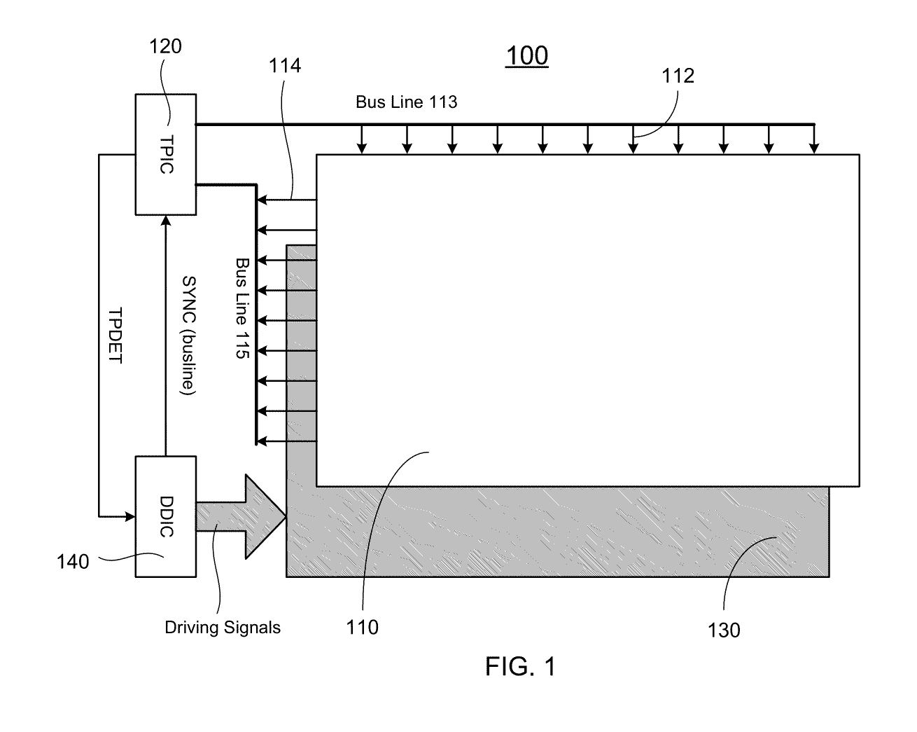

The description will be made as to the embodiments of the present disclosure in conjunction with the accompanying drawings in FIGS. 1-11. In accordance with the purposes of this disclosure, as embodied and broadly described herein, this disclosure, in one aspect, relates to methods and systems that utilize dynamic stop display frame driving mechanisms for touch sensing of a touch display device. The driving methods and systems are particularly adapted for an LCD touch display, where the liquid crystals have response times long enough so that even if the driving of thin film transistors (TFTs) of pixels is stopped/disabled for a while, for example, for one or more frames, the pixels can still hold enough voltage levels as so to keep the image displaying at the same grey level without compromising the display quality. The touch sensing is then performed within the period of the one or more frames when no display driving is performed. It should be appreciated that the disclosure is not restricted in LCD touch display devices, and any kind of display devices having the characteristic of keeping the image quality for a frame time with stopping display driving can also be utilized to practice the disclosure.

Referring to FIG. 1, a touch display 100 is schematically shown according to one embodiment of the disclosure. In the exemplary embodiment, the touch display 100 has a touch sensing device 110 and a display device 130. The touch sensing device 110 and the display device 130 can be made in an integrated panel or in two individual panels. The former corresponds to an in-cell touch display device, where the display device and touch sensing device are integrated into one panel instead of stacking up in separate layers. The touch display 100 also includes a driving system having a touch sensing device integrated circuit (TPIC) 120 for driving the touch sensing device 110 to sense a touch event thereon and a display driving integrated circuit (DDIC) 140 for driving the display device 130 to display an image thereon. The display driving controller 140 and the touch sensing controller 120 are synchronized with each other such that when the display device 130 is not driven in selected frames of the series of frames, the touch sensing device 110 is driven, and when the display device 130 is driven in the other frames of the series of frames, the touch sensing device 110 is not driven. The TPIC 120 and the DDIC 140 are also known as a touch sensing controller and a display driving controller, respectively. The terms “touch sensing device integrated circuit” or “TPIC”, and “display driving integrated circuit” or “DDIC” are respectively exchangeable with the terms “touch sensing controller” and “display driving controller” in the disclosure.

The touch sensing device 110 has a plurality of scanning lines (TX) 112 spatially arranged along a column direction and a plurality of sensing lines (RX) 114 spatially arranged crossing over the plurality of scanning lines 112 along a row direction, which are electrically coupled to the TPIC 120 through, for example, bus lines 113 and 115, respectively. In operation, the TPIC 120 acquires signals sensed by the sensing lines 114 when each scanning line 112 starts being scanned, and processes the acquired signals to determine whether a touch event exists and the coordinates of the touch event if existed.

The display device 130 can be an LCD device or any kind of display devices having the characteristic of keeping the image quality for a frame time with stopping display driving. The display device 130 is driven by driving signals generated by the DDIC 140 to display an image. Generally, the DDIC 140 also provides, among other driving signals, vertical synchronization signals, VSYNC, and horizontal synchronization signals, HSYNC, for controlling the display device 130 to display the image in terms of a series of frames. Each vertical synchronization signal VSYNC is a synchronization signal representing a beginning of a frame and defines a frame period, FP, of a frame. Each horizontal synchronization signal HSYNC is a synchronization signal representing a beginning to scan one of a plurality of scan lines of the display device 130. In one frame, a plurality of horizontal synchronization signals HSYNC defines line scanning periods of the plurality of scan lines of the display device 130. Each frame has a frame displaying period, FDP, and a frame blanking period, FBP. Each line scanning has a line scanning period and a blanking period. The vertical synchronization signals VSYNC and the horizontal synchronization signals HSYNC are usually generated from a timing controller (TCON), which is not shown in FIG. 1 and can be integrated in the DDIC 140 or an individual IC. In this exemplary embodiment, VSYNC and HSYNC are provided from the DDIC 140 to the TPIC 120 through SYNC bus lines for synchronizing the operations of the DDIC 140 and the TPIC 120.

Usually, the display device 130 is driven during the frame displaying period and is not driven during the frame blanking period for each frame of the image, i.e. the display driving system is not liable to influence the touch sensing during the frame blanking periods. Accordingly, the TPIC 120 can enable a sensing operation during the frame blanking periods, and disable the sensing operation after the frame blanking period is ended. Further, as described above, the horizontal synchronization signals define a plurality of line scanning periods in one frame and the line blanking period between two adjacent line scanning periods. The display device 130 is not driven during the line blanking periods, i.e. the display driving system is not liable to influence the touch sensing during the line blanking periods. Therefore, the TPIC 120 can enable a sensing operation during the line blanking periods, and disable the sensing operation after the line blanking period is ended. In other words, the TPIC 120 can enable the sensing operation during the frame blanking periods and/or the line blanking periods, and disable the sensing operation during a period other than the frame blanking period and the line blanking period.

According to the disclosure, the touch display 100 can selectively operates in a normal display mode or in a stop mode. In the normal display mode, the touch display 100 is configured such that the display device 130 is driven by the DDIC 140 in each line scanning period of each frame and in the frame displaying period of frames to update the image, while the touch sensing device 110 is driven by the TPIC 120 during the frame and line blanking periods to sense the touch event. In the stop mode, the touch display 100 is configured such that when the display device 130 is not driven the DDIC 140 in selected frames of the series of frames, the touch sensing device 110 is driven by the TPIC 120, and when the display device 130 is driven the DDIC 140 in the other frames of the series of frames, the touch sensing device 110 is not driven by the TPIC 120.

Without intent to limit the scope of the disclosure, the following exemplary embodiments according to the embodiments of the disclosure discuss operations of the stop mode of the touch display 100.

According to the invention, the display driving controller (i.e., DDIC) 140 is configured to selectively stop/disable the driving of the display device 130 for selected frames of the series of frames, and perform/enable the driving of the display device 130 for the other frames of the series of frames. The touch sensing controller (i.e., TPIC) 120 is configured to perform/enable the driving of the touch sensing device 110 during the selected frames in which the display device is not driven, and stop/disable the driving of the touch sensing device during the other frames in which the display device is driven. The selected frames are selected from the series of frames in accordance with a touch event of the touch sensing device, display charging times of the display device, variation of grey level, or manual setting. In one embodiment, the selected frames are regularly selected from the series of frames, for example, the selected frames are the odd frames, i.e., (2k+1)-th frames, of the series of frames, the even frames, i.e., (2k)-th frames, of the series of frames, (3k)-th frames of the series of frames, or a certain frame in each k frames of the series of frames, where k is an positive integer. In another embodiment, the selected frames are irregularly selected from the series of frames. For example, the selected frames can be selected from the series of frames in accordance with a touch event of the touch sensing device 110 or display charging times of the display device 130.

Alternatively, the touch sensing controller 120 and the display driving controller 140 are synchronized with each other such that when the display device 130 is not driven during selected frames of the series of frames, the touch sensing device 110 is driven, and when the display device 130 is driven during the other frames of the series of frames, the touch sensing device 110 is not driven.

In one embodiment, stopping driving the display device 130 in the selected frames and driving the display device 130 in the other frames are triggered by a display trigger, which is a DDIC internal signal configured in accordance with a touch event of the touch sensing device, display charging times of the display device, variation of grey level, or manual setting.

In one embodiment, the touch sensing controller 120 is configured to drive the touch sensing device 110 in frame and line blanking periods, and provide a touch detection signal TPDET such that when a touch event is sensed, the touch detection signal is set from a low level to a high level for a time period, while the display driving controller 140 is configured to detect the touch detection signal TPDET in each frame blanking period, and drive the display device when the touch detection signal TPDET is in the low level, and when the touch detection signal TPDET is in the high level, and stop driving the display device 130 in at least one frame immediately after the corresponding frame of the start of the high level until the touch detection signal TPDET is in the low level.

In another embodiment, the touch sensing controller 120 is configured to drive the touch sensing device 110 in frame and line blanking periods, while the display driving controller 140 is configured to drive the display device 130, and when a touch event is sensed in a frame blanking period, stop driving the display device in at least one frame immediately after the corresponding frame of the frame blanking period.

In yet another embodiment, the display driving controller is configured to drive the display device in the other frames and in part of the selected frames such that certain frames of the other frames are repeatedly displayed in corresponding frames of the other frames and its adjacent selected frames as to reduce current leaking times in the selected frames, while wherein the touch sensing controller is configured to drive the touch sensing device to sense a touch event during the reduced current leaking times for which the display is not driven.

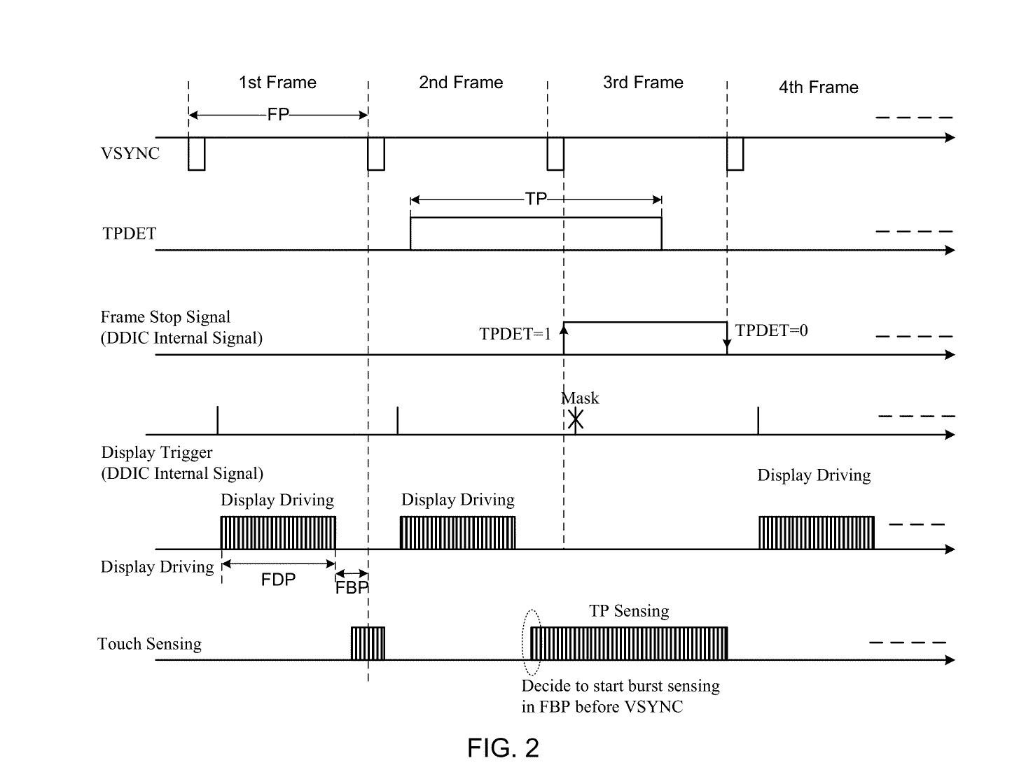

Still referring to FIG. 1 and also referring to FIG. 2, in one exemplary embodiment, the touch sensing controller 120 and the display driving controller 140 are synchronized with each other by VSYNC and HSYNC. In operation, when no touch event is sensed by the touch sensing controller 120, a display trigger, for example, a DDIC internal signal YDIO, is enabled, then the display driving controller 140 starts to drive the display device 130. The touch sensing controller 120 drives the touch sensing device 110 in frame and line blanking periods to sense a touch event, and provides a touch detection signal TPDET, which is set from a low level to a high level for a time period, TP, when a touch event is sensed. The display driving controller 140 detects the touch detection signal TPDET. Accordingly, the display trigger is then disabled when the touch detection signal is in the high level. The display driving controller 140 then stops the display device 1130, and the touch sensing controller 120 drives the touch sensing device 110 to sense the touch event by burst sensing during the frame immediately after the corresponding frame of the start of the high level of the touch detection signal, which is a longer period than frame blanking period or line blanking period. As shown in FIG. 2, the touch sensing controller 120 senses a touch event (represented by TPIC Sensing) in the frame blanking period FBP of the second frame, the touch detection signal TPDET is enabled and then set from a low level to a high level for the time period TP that is not shorter than one frame period, FP. In this example, the time period TP of the high level lasts to the third frame.

The display driving controller 140 detects the touch detection signal TPDET in each of the frame and line blanking periods, drives the display device 130 when the touch detection signal TPDET is in the low level, and when the touch detection signal TPDET is in the high level, stops driving the display device in at least one frame immediately after the corresponding frame of the start of the high level until the touch detection signal TPDET is in the low level. In this example shown in FIG. 2, the touch event 221 is sensed in the frame blanking period of the second frame, i.e., the high level of the touch detection signal TPDET, for example, TPDET=1, is detected to start in the frame period of the second frame. Accordingly, the display driving controller 140 generates a frame stop signal (DDIC Internal Signal) to mask display trigger in the frame period of the third frame that is immediately after the second frame, to stop/disable the driving of the display device 130 in the third frame. The driving of the display device 130 is then restored/enabled in the frame period of the fourth frame, since the touch detection signal TPDET has the low level therein, for example, TPDET=0. As shown in FIG. 2, in the exemplary embodiment, the display device 130 is driven by a DDIC signal in the frame displaying periods of the first, second and fourth frames, while the driving of the display device 130 is stopped in the frame period of the third frame.

During the frame period of the third frame the display trigger is not enabled, in which no display device is driven, the touch sensing controller 120 drives the touch sensing device 110 to sense the touch event by burst sensing during a longer period than frame blanking period or line blanking period. As such, the frame period of the third frame is long enough for the touch sensing controller 120 to perform continually burst sensing or repeated sensing of the touch event as so to accurately determine the coordinates, and yet to prevent interferences from the driving of the display device 130.

In the exemplary embodiment shown in FIG. 2, the selected stopping frames (e.g., the third frame) are dynamically and irregularly determined in accordance with a touch event of the touch sensing device.

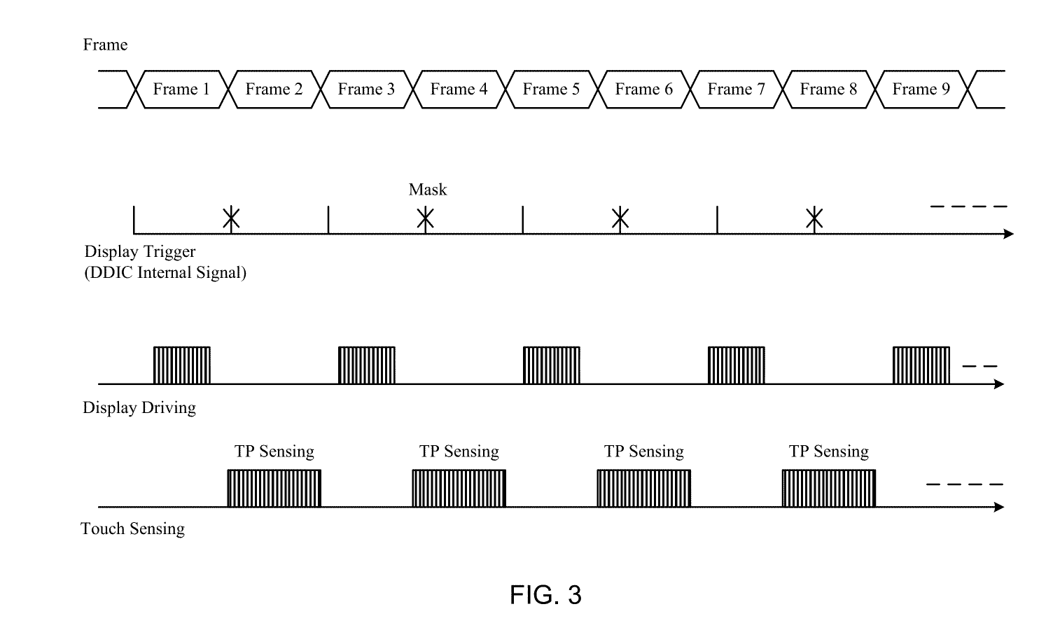

In another embodiment, the selected stopping frames can be regularly selected, for example, in the even frames of the series of frames of the image, as shown in FIG. 3. In this case, no touch detection signal TPDET may be needed, the display trigger is configured to enable display driving at the odd frames and stop display driving at the selected even frames, and the display driving controller will automatically stop driving the display device at these regularly selected even frames based on the counting of the frames in accordance with the display trigger, and the touch sensing controller performs burst sensing or repeated sensing of the touch event these regularly selected even frames.

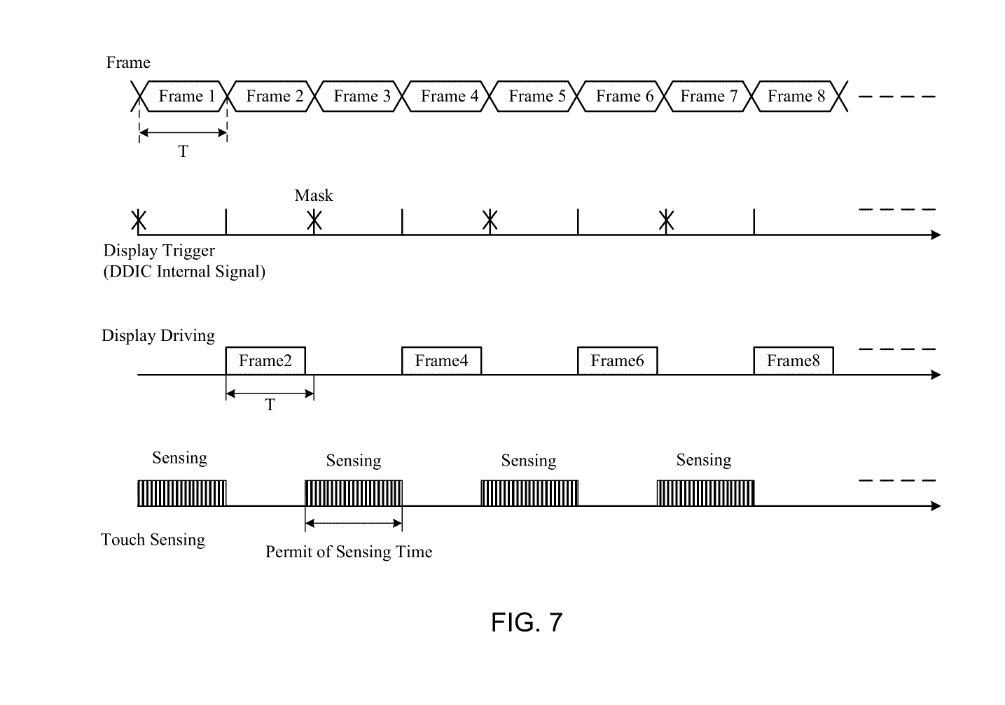

It should be appreciated to people skilled in the art that the odd frames of the series of frames of the image, as shown below in FIG. 7, or the likes, can also be selected as the selected stopping frames. Also, it should also be appreciated to people skilled in the art that it can be selected to stop display driving at a certain frame in each k frames.

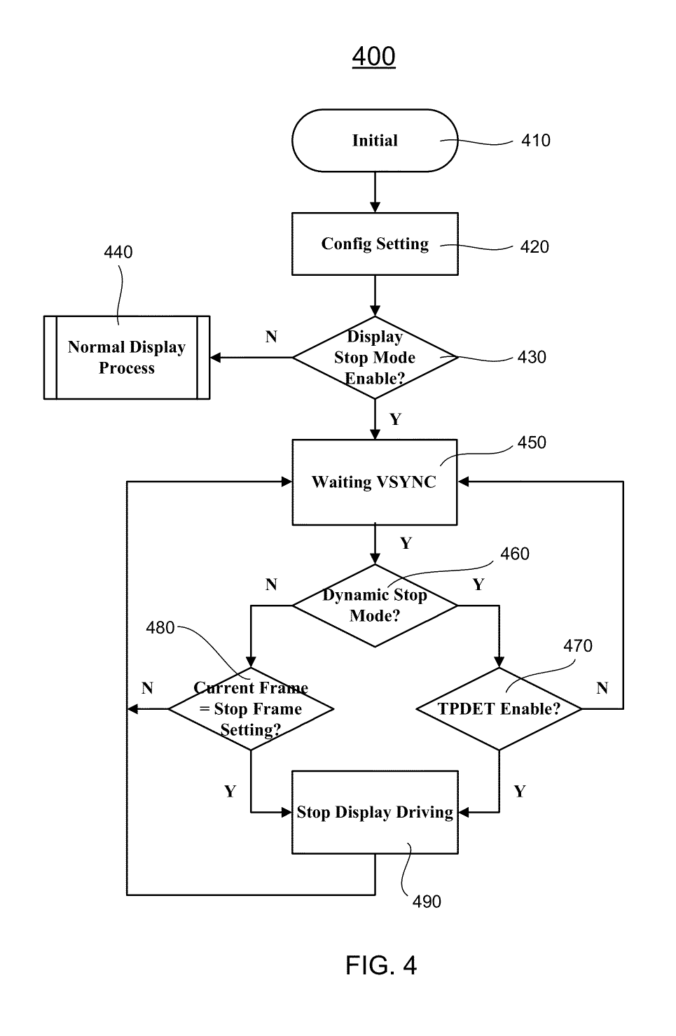

Referring to FIG. 4, a flowchart 400 of operations of a display driving controller, i.e., DDIC, to drive a touch display is schematically shown according to one embodiment of the disclosure. At first, the touch display is initialized (at step 410). Then, the configuration setting is performed at step 420. The execution of steps 410 and 420 may be automatically performed when the display driving controller is powered on. Next, it is determined that whether the display stop mode is enabled (at step 430), for example, based on the configuration setting at step 420, manual setting, or in accordance with variation of grey level, while variation of grey level is smaller than a presumed value. If the display stop mode is not enabled, i.e., the display stop mode is off, the touch display is driven in a normal display process at step 440. In the normal display mode, the display device is driven by the DDIC in the line scanning periods of each frame, and the frame displaying period of the frames to update the image, while the touch sensing device is driven by the TPIC during the frame and line blanking periods to sense the touch event. Preferably, the display stop mode is set to be normally on.

When the display stop mode is on, it is determined whether a VSYNC occurs at step 450. If the VSYNC occurs, it further determines whether the display device operates in a dynamic stop mode at step 460 or not. If the display device operates in the dynamic stop mode, the touch sensing controller drives the touch sensing device in frame and line blanking periods to sense a touch event and provides a touch detection signal TPDET, while the display driving controller determines whether a touch detection signal TPDET is enabled at step 470, for example, determines whether the touch detection signal TPDET is in a high level., i.e., whether a touch event occurs in frame blanking period. If the touch detection signal TPDET is enabled, i.e., in the high level indicating that the touch event occurs, the display driving controller stops driving the display device at step 490, otherwise, if the touch detection signal TPDET is not enabled, i.e., in a low level indicating that no touch event occurs, the display driving controller waits for the next VSYNC at step 450. Additionally, if it is determined that the display device does not operate in the dynamic stop mode at step 460, the display driving controller determines whether the current frame is corresponding to the stop frame setting at step 480, if yes, the display driving controller stops driving the display device at step 490, otherwise, the display driving controller waits for the next VSYNC at step 450. Furthermore, after the driving of the display device in the selected frame is stopped at step 490, the display driving controller waits for the next VSYNC at step 450. The processes are repeated until the last VSYNC for the last frame of the series of frames.

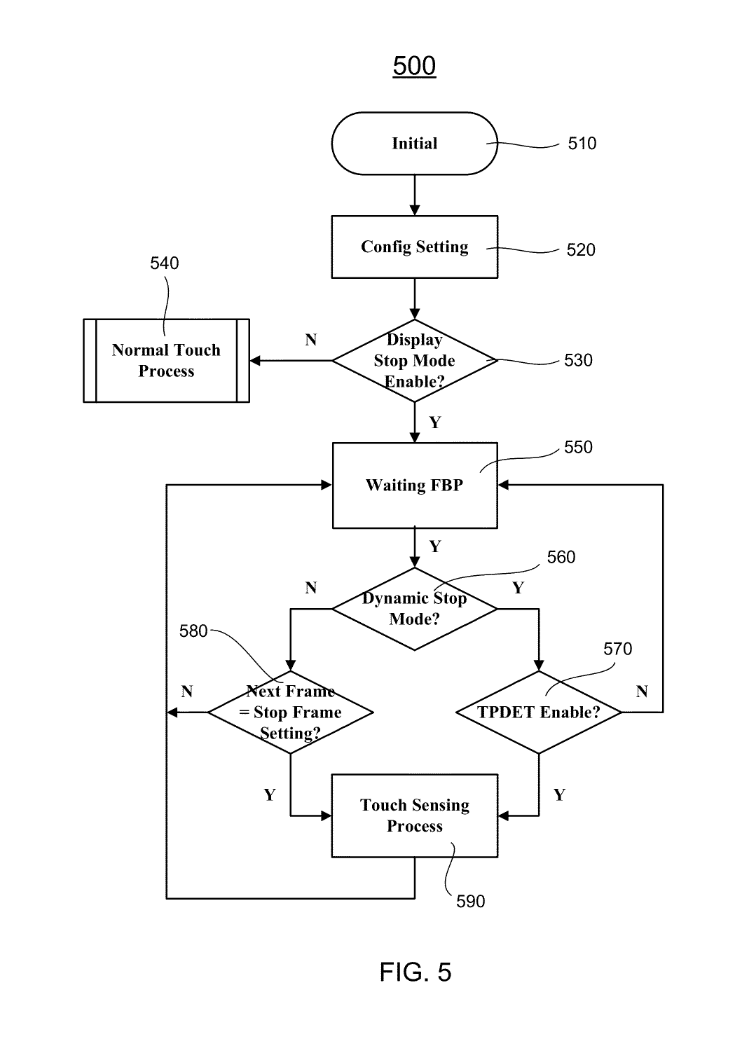

Referring to FIG. 5, a flowchart 500 of operations of a touch sensing controller, i.e., TPIC, to drive a touch display is schematically shown according to one embodiment of the disclosure. At first, the touch display is initialized (at step 510). Then, the configuration setting is performed at step 520. The execution of steps 510 and 520 may be automatically performed when the touch sensing controller is powered on. Next, it is determined whether the display stop mode is enabled (at step 530), for example, based on the configuration setting at step 520. If the display stop mode is not enabled, the normal touch process for the touch sensing device is executed at step 540. In the normal display mode, the display device is driven by the DDIC in the line scanning periods of each frame, and the frame displaying period of the frames to update the image, while the touch sensing device is driven by the TPIC during the frame and line blanking periods to sense the touch event. Preferably, the display stop mode is set to be normally on.

When the display stop mode is enabled, it is determined whether it is currently in a frame blanking period, FBP, at step 550. If it is in the FBP, it is determined whether the display device operates in a dynamic stop mode at step 560. If the display device operates in the dynamic stop mode, the touch sensing controller drives the touch sensing device in frame and line blanking periods to determines whether a touch event occurs and provides a touch detection signal TPDET accordingly, while the display driving controller detects the touch detection signal TPDET and determines whether it is enabled at step 570. If the touch detection signal TPDET is enabled, i.e., the driving of the display device is stopped in the frame immediately after the next frame where the touch detection signal TPDET is enabled, the touch sensing controller performs burst touch sensing process at step 590. If the touch detection signal TPDET is not enabled, the touch sensing controller waits for the next FBP at step 550. Additionally, if it is determined that the display device does not operate in the dynamic stop mode at step 560, the display driving controller determines whether the next frame is corresponding to the stop frame setting at step 580, if yes, the display driving controller stops driving the display device in the frame, and the touch sensing controller performs burst touch sensing process at step 590, otherwise, the touch sensing controller waits for the next FBP at step 550. Furthermore, after the burst touch sensing process is performed at step 590, the touch sensing controller waits for the next FBP at step 550. The processes are repeated until the last FBP for the last frame of the series of frames.

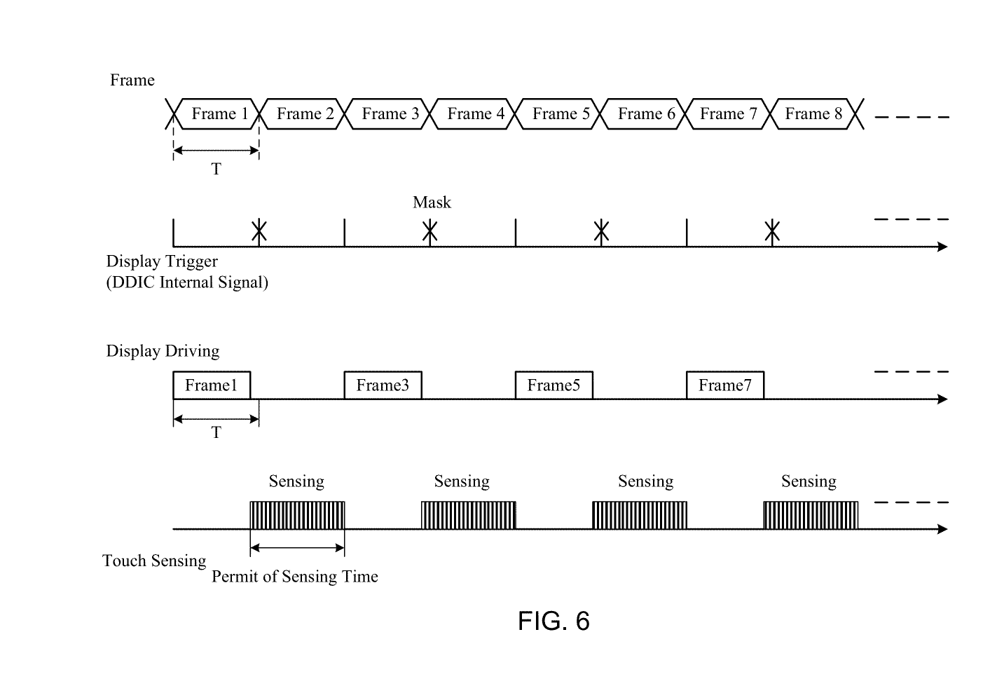

FIG. 6 shows schematically a driving scheme for a touch display according to one embodiment of the disclosure. Similar to the driving signals shown in FIG. 3, the even frames of the series of frames of the image are selected as the stopping frames for which the touch sensing is performed. Except that the display driving controller will automatically stop driving the display device at these regularly selected even frames based on a display trigger, which is masked at the even frames. Accordingly, the display driving is enabled in the odd frames and stopped in the masked even frames by the display driving controller, while the touch sensing is performed in the masked even frames where the display device is not driven and stopped in the in the odd frames where the display device is driven by the touch sensing controller.

FIG. 7 shows schematically a driving scheme for a touch display according to another embodiment of the disclosure. In this exemplary embodiment, the odd frames of the series of frames of the image are selected as the stopping frames for which the touch sensing is performed. Similarly, the display driving controller will automatically stop driving the display device at these regularly selected odd frames based on a display trigger, which is masked at the odd frames. Accordingly, the display driving is enabled in the even frames and stopped in the masked odd frames by the display driving controller, while the touch sensing is performed in the masked odd frames where the display device is not driven and stopped in the in the even frames where the display device is driven by the touch sensing controller.

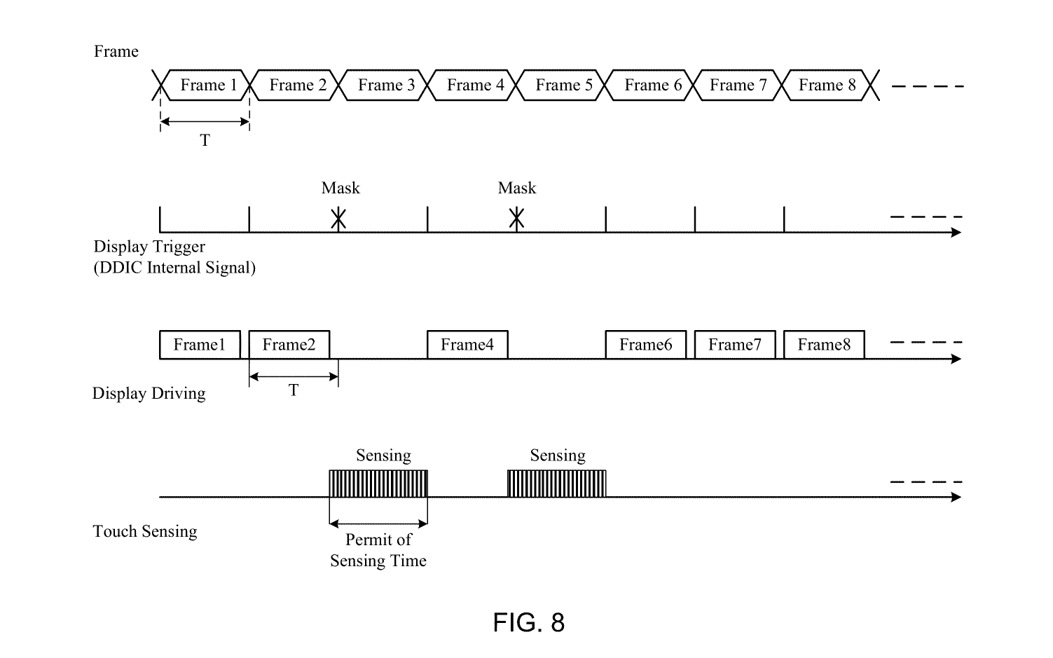

FIG. 8 shows schematically a driving scheme for a touch display according to yet another embodiment of the disclosure. Similar to that shown in FIGS. 6 and 7, the stop frame driving is also selected based on a display trigger, YDIO. However, in the exemplary embodiment, the display trigger YDIO is masked at irregular frames. For example, as shown in FIG. 8, the third and fifth frames are masked. Therefore, the driving of the display device is stopped at the masked third and fifth frames, the touch sensing is performed in the masked third and fifth frames by the touch sensing device sensing controller.

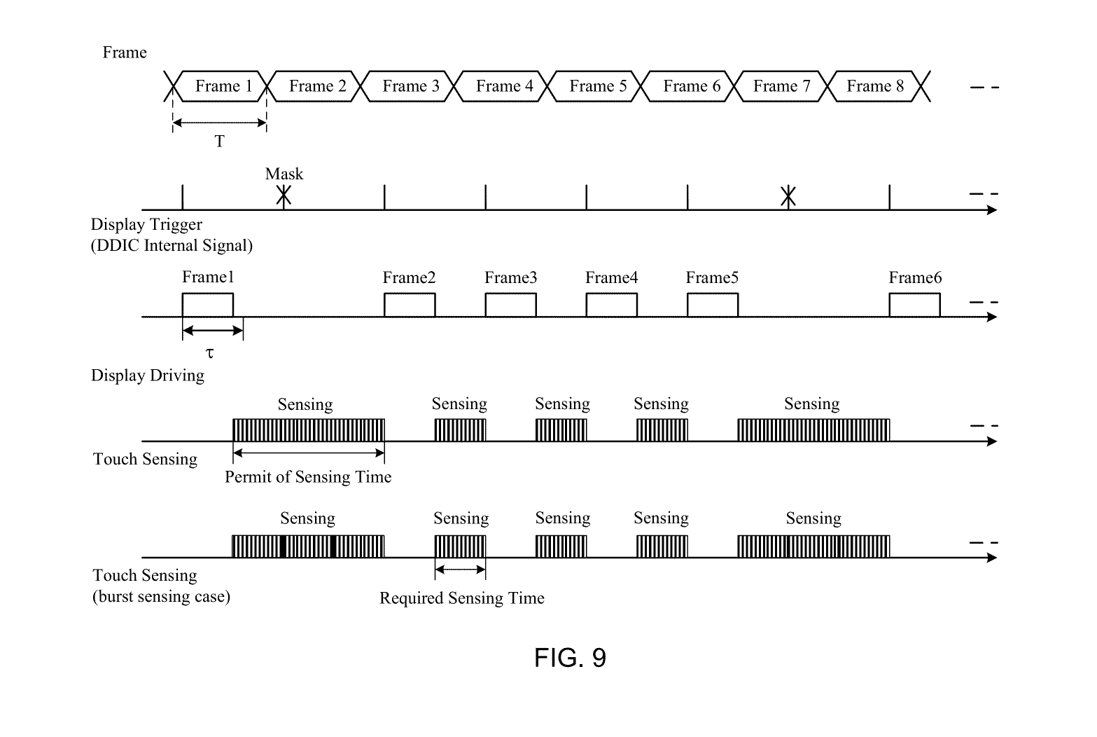

Generally, for an LCD device, the frame period of a frame includes a charging time of pixel and a frame blanking period. The shorter the charging time is, the longer the blanking period is. The faster the pixel is charged, the shorter the charging time is. By adjusting the display charging time, for example, through fabricating processes and materials of the pixel, the frame blanking period may be increased. Accordingly, the touch sensing is performed in the increased frame blanking periods. FIG. 9 shows schematically a driving scheme for a touch display according to a further embodiment of the disclosure, where dynamic stop frame driving is in accordance with display charging time adjustments, in addition with a display trigger. As shown in FIG. 9, for a display device having a frame refreshing rate of 60 Hz, the frame period T is about 16.67 ms. By adjusting the display charging time, the actual frame period τ of a frame for which the display device is driven is less than 16.67 ms. Accordingly, the frame blanking period is long enough to perform the touch sensing and yet to prevent the interference from the driving of the display device. Also, according to the touch sensing requirements, the stop frame driving is also selected based on a display trigger, YDIO, as discussed above. In this example shown in FIG. 9, the driving of the display device is stopped in the second and seventh frames based on the display trigger YDIO that is masked at the second and seventh frames. Meanwhile, the frame blanking periods are increased. Accordingly, the touch sensing is performed in the second and seventh frames, and other blanking periods.

Additionally, the time for stop driving the pixel is affected by the current leakage of thin film transistors (TFTs). If the amounts of the current leakage are large, the time for which the pixel can hold a certain voltage level is reduced. Different fabricating processes and materials of the TFTs may lead to different current leakages of the TFTs. For example, the current leakage of an amorphous silicon (a-Si) TFT is larger than that of an indium gallium zinc oxide (IGZO) TFT, as shown in Table 1. Since the IGZO TFT charges low current leakage, it can be well suit to the frame stop mechanism for touch sensing.

TABLE 1
fabricating process and the current leakage of a-Si and IGZO TFTs

| | | IGZO |
|---|---|---|
| TFT Process | a-Si | (Transparent Oxide) |
| Carrier Mobility (cm²/Vs) | <1 | 1~100 |
| Current Leakage (pA) | 1~100 | 0.1~100 |

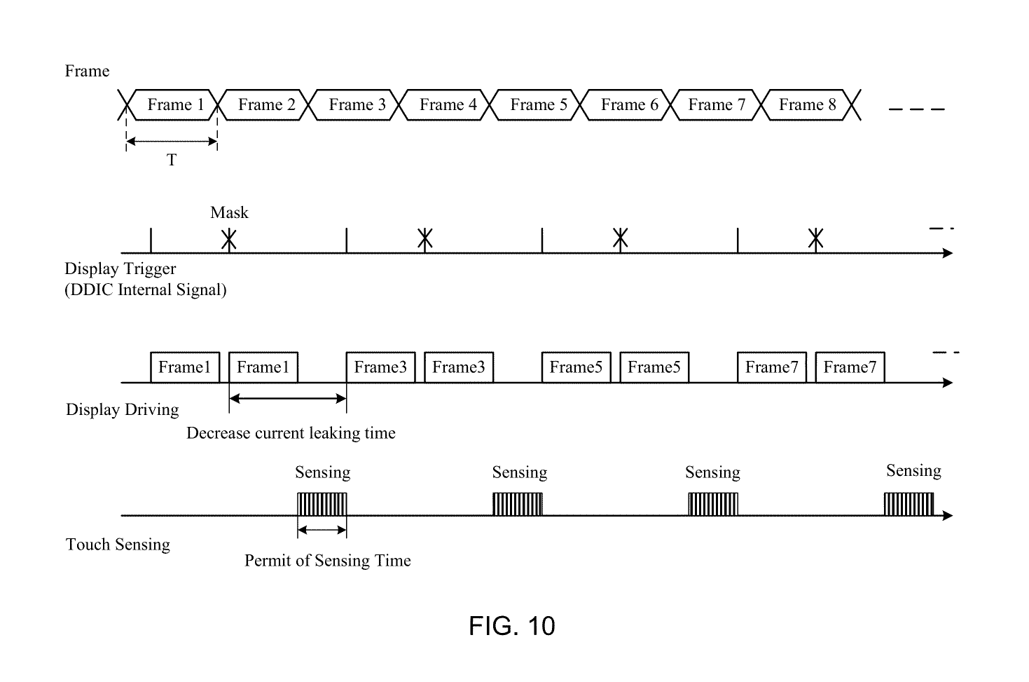

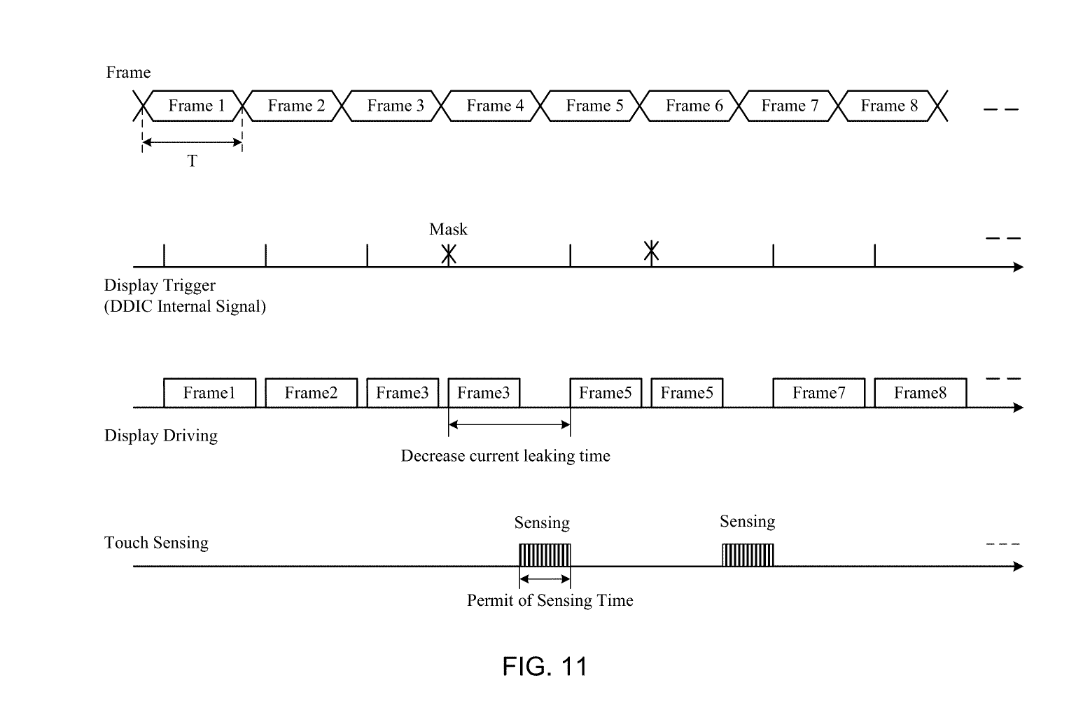

Even though an a-Si TFT has higher current leakage than that of an IGZO TFT, it still can be suited to the stop frame driving mechanism for touch sensing, with appropriate charging time adjustment if necessary. FIGS. 10 and 11 show schematically driving schemes for the stop frame driving mechanism with a-Si TFTs for touch sensing according to embodiments of the present disclosure. In these exemplary schemes, the display device is driven such that each particular frame, for example, the odd frames in FIG. 10, and irregular frames in FIG. 11, is sequentially displayed twice. Specifically, for the exemplary scheme shown in FIG. 10, the even frames are selectively masked, so that these even frames are not displayed. The display device is driven in the odd frame displaying periods to display the odd frames. Furthermore, the display device is also consecutively driven in the even frame displaying periods to repeatedly display the odd frames, i.e., each odd frame is displayed twice in the two consecutive odd and even frame displaying periods. Similarly, for the exemplary scheme shown in FIG. 11, the fourth and sixth frames are selectively masked, so that the fourth and sixth frames are not displayed. The display device is driven in the each and every frame displaying period. But in the third and fourth frame displaying periods, the display device is driven to display the third frame twice, while in the fifth and sixth frame displaying periods, the display device is driven to display the fifth frame twice. Accordingly, the current leaking time for which the display device is not driven is decreased. The current leaking time is corresponding to the frame blanking period between the selected frame and its adjacent frame. The frame blanking period is long enough to perform the touch sensing and yet to prevent the interference from the driving of the display device.

In sum, the disclosure, among other things, recites methods and systems that utilize dynamic stop frame driving mechanisms for touch sensing of a touch display.

In one aspect, the method includes driving the touch sensing device in frame and line blanking periods; driving the display device, and when a touch event is sensed in a blanking period, stopping driving the display device in a frame immediately after the corresponding frame of the frame blanking period; and driving the touch sensing device to sense the touch event during the frame immediately after the corresponding frame of the frame blanking period in which the display device is not driven.

The method may further includes providing a touch detection signal such that when a touch event is sensed, the touch detection signal is set from a low level to a high level for a time period, where the time period is not shorter than one frame period.

In one embodiment, the stopping of driving the display device comprises detecting the touch detection signal in each frame blanking period; and stopping driving the display device in at least one frame immediately after the corresponding frame of the start of the high level of the touch detection signal until the touch detection signal is in the low level.

In another aspect, the method includes performing a driving operation for the display device, and a sensing operation for the touch sensing device, where the driving operation is configured such that for selected frames of the series of frames, the display device is not driven, and for the other frames of the series of frames, the display device is driven; and the sensing operation is configured such that during the selected frames in which the display device is not driven, the touch sensing device is driven, and during the other frames in which the display device is driven, the touch sensing device is not driven. The selected frames are selected from the series of frames in accordance with a touch event of the touch sensing device, display charging times of the display device, variation of grey level, or manual setting. The selected frames are regularly or irregularly selected from the series of frames.

In one embodiment, the driving operation comprises providing a display trigger to drive the display device or stop driving the display device.

The driving operation and the sensing operation are synchronized with each other such that when the display device is not driven during the selected frames, the touch sensing device is driven, and the display device is driven during the other frames, the touch sensing device is not driven.

In one embodiment, the sensing operation comprises driving the touch sensing device in frame and line blanking periods to sense a touch event; and providing a touch detection signal such that when a touch event is sensed, the touch detection signal is set from a low level to a high level for a time period. The driving operation comprises detecting the touch detection signal in each frame blanking period; and driving the display device when the touch detection signal is in the low level, and when the touch detection signal is in the high level, stopping driving the display device in at least one frame immediately after the corresponding frame of the start of the high level until the touch detection signal is in the low level.

In another embodiment, the sensing operation comprises driving the touch sensing device in frame blanking periods to sense a touch event. The driving operation comprises when a touch event is sensed in a frame blanking period, stopping driving the display device in at least one frame immediately after the corresponding frame of the frame blanking period.

The sensing operation further comprises driving the touch sensing device to sense a touch event during the at least one frame immediately after the corresponding frame of the start of the high level of the touch detection signal.

In yet another embodiment, the driving operation comprises driving the display device in the other frames and in part of the selected frames such that certain frames of the other frames are repeatedly displayed in corresponding frames of the other frames and its adjacent selected frames as to reduce current leaking times in the selected frames while the sensing operation comprises driving the touch sensing device to sense a touch event during the reduced current leaking times for which the display is not driven.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for driving a touch display for sensing a touch event and displaying an image characterized with a series of frames, comprising:
driving a touch sensing device of the touch display in frame and line blanking periods;
driving a display device of the touch display, and when a touch event is sensed in a blanking period, stopping driving the display device in a frame immediately after the corresponding frame of the frame blanking period; and
driving the touch sensing device to sense the touch event during the frame immediately after the frame blanking period in which the display device is not driven.

2. The method of claim 1, further comprising:
providing a touch detection signal such that when a touch event is sensed, the touch detection signal is set from a low level to a high level for a time period.

3. The method of claim 2, wherein the time period is not shorter than one frame period.

4. The method of claim 2, wherein the stopping of driving the display device comprises:
detecting the touch detection signal in each frame blanking period; and
stopping driving the display device in at least one frame immediately after the corresponding frame of the start of the high level of the touch detection signal until the touch detection signal is in the low level.

5. The method of claim 1, wherein the display device and the touch sensing device are integrated into a single in-cell touch display panel or stacked up in separate panels.

6. A method for driving a touch display for sensing a touch event and displaying an image characterized with a series of frames, comprising:
performing a driving operation for a display device of the touch display, and a sensing operation for a touch sensing device of the touch display,
wherein the driving operation is configured such that for selected frames of the series of frames, the display device is not driven, and for the other frames of the series of frames, the display device is driven; and
wherein the sensing operation is configured such that during the selected frames in which the display device is not driven, the touch sensing device is driven, and during the other frames in which the display device is driven, the touch sensing device is not driven.

7. The method of claim 6, wherein the driving operation comprises:
providing a display trigger to drive the display device or stop driving the display device.

8. The method of claim 6, wherein the selected frames are selected from the series of frames in accordance with a touch event of the touch sensing device, display charging times of the display device.

9. The method of claim 8, wherein the selected frames are regularly selected from the series of frames.

10. The method of claim 9, wherein the selected frames are the odd frames of the series of frames, or the even frames of the series of frames.

11. The method of claim 8, wherein the selected frames are irregularly selected from the series of frames.

12. The method of claim 6, wherein the driving operation and the sensing operation are synchronized with each other such that when the display device is not driven during the selected frames, the touch sensing device is driven, and the display device is driven during the other frames, the touch sensing device is not driven.

13. The method of claim 12, wherein the sensing operation comprises:
driving the touch sensing device in frame and line blanking periods to sense a touch event; and
providing a touch detection signal such that when a touch event is sensed, the touch detection signal is set from a low level to a high level for a time period; and
wherein the driving operation comprises:
detecting the touch detection signal in each frame blanking period; and
driving the display device when the touch detection signal is in the low level, and when the touch detection signal is in the high level, stopping driving the display device in at least one frame immediately after the corresponding frame of the start of the high level until the touch detection signal is in the low level.

14. The method of claim 13, wherein the sensing operation further comprises:
driving the touch sensing device to sense a touch event during the at least one frame immediately after the corresponding frame of the start of the high level of the touch detection signal.

15. The method of claim 12, wherein the sensing operation comprises:
driving the touch sensing device in frame and line blanking periods to sense a touch event; and
wherein the driving operation comprises:
when a touch event is sensed in a frame blanking period, stopping driving the display device in at least one frame immediately after the corresponding frame of the frame blanking period.

16. The method of claim 15, wherein the sensing operation further comprises:
driving the touch sensing device to sense a touch event during the at least one frame immediately after the corresponding frame of the frame blanking period.

17. The method of claim 12, wherein the driving operation comprises:
driving the display device in the other frames and in part of the selected frames such that certain frames of the other frames are repeatedly displayed in corresponding frames of the other frames and its adjacent selected frames as to reduce current leaking times in the selected frames; and
wherein the sensing operation comprises:
driving the touch sensing device to sense a touch event during the reduced current leaking times for which the display is not driven.

18. A driving system for a touch display having a touch sensing device for sensing a touch event and a display device for displaying an image characterized with a series of frames, comprising:
a display driving controller; and
a touch sensing controller,
wherein the display driving controller and the touch sensing controller are synchronized with each other such that when the display device is not driven in selected frames of the series of frames, the touch sensing device is driven, and when the display device is driven in the other frames of the series of frames, the touch sensing device is not driven.

19. The driving system of claim 18, wherein the selected frames are regularly selected from the series of frames, or irregularly selected from the series of frames.

20. The driving system of claim 18, wherein the selected frames are selected from the series of frames in accordance with a touch event of the touch sensing device or display charging times of the display device, variation of grey level, or manual setting.

21. The driving system of claim 18, wherein the display driving controller is configured to provide a display trigger to drive the display device or stop driving the display device in accordance with a touch event of the touch sensing device or display charging times of the display device.

22. The driving system of claim 18,
wherein the touch sensing controller is configured to drive the touch sensing device in frame and line blanking periods, and provide a touch detection signal such that when a touch event is sensed, the touch detection signal is set from a low level to a high level for a time period; and
wherein the display driving controller is configured to detect the touch detection signal in each frame blanking period, and drive the display device when the touch detection signal is in the low level, and when the touch detection signal is in the high level, stop driving the display device in at least one frame immediately after the corresponding frame of the start of the high level until the touch detection signal is in the low level.

23. The driving system of claim 18,
wherein the touch sensing controller is configured to drive the touch sensing device in frame and line blanking periods; and
wherein the display driving controller is configured to drive the display device, and when a touch event is sensed in a blanking period, stop driving the display device in at least one frame immediately after the corresponding frame of the frame blanking period.

24. The method of claim 18,
wherein the display driving controller is configured to drive the display device in the other frames and in part of the selected frames such that certain frames of the other frames are repeatedly displayed in corresponding frames of the other frames and its adjacent selected frames as to reduce current leaking times in the selected frames; and
wherein the touch sensing controller is configured to drive the touch sensing device to sense a touch event during the reduced current leaking times for which the display is not driven.

25. The method of claim 18, wherein the display device and the touch sensing device are integrated into a single in-cell touch display panel or stacked up in separate panels.
